(19) United States
(12) Patent Application Publication
(10) Pub. No.: US 2017/0149269 A1
(43) Pub. Date: May 25, 2017

(54) SYSTEMS AND METHODS FOR ELECTRIC CHARGING OF WEIGHTLIFTING IMPLEMENTS

(71) Applicant: Iron Grip Barbell Company, Inc., Santa Ana, CA (US)

(72) Inventors: Michael D. Rojas, Santa Ana, CA (US); Scott Frasco, Santa Ana, CA (US)

(21) Appl. No.: 15/360,835

(22) Filed: Nov. 23, 2016

Related U.S. Application Data
(60) Provisional application No. 62/258,995, filed on Nov. 23, 2015.

(51) Int. Cl. H02J 7/02; A63B 21/00; A63B 71/00; A63B 21/072

(52) U.S. Cl. CPC H02J 7/025; A63B 21/0726; A63B 21/0724; A63B 21/4033; A63B 71/0036; A63B 2220/40

(57) ABSTRACT

Embodiments of the present disclosure are directed to a system for wirelessly charging one or more weightlifting implement via inductive coupling.

### CROSS REFERENCE TO RELATED APPLICATION

This application claims the benefit under 35 U.S.C. §119(e) of U.S. Provisional Application No. 62/258,995 filed on Nov. 23, 2015, the content of which is incorporated by reference in its entirety into the present disclosure.

### TECHNICAL FIELD

The disclosed technology relates generally to electric charging systems and methods, and more particularly, some embodiments relate to the electric charging of monitoring and transmitting systems in weightlifting implements.

### BACKGROUND

U.S. Pat. No. 6,014,078 describes a monitoring system for detecting weightlifting implements returned to respective receptacles formed in a weightlifting storage device, such as a rack. In the event the implements are placed in improper locations in or on the storage device, the monitoring system is operative to generate an error signal, which may be in the form of an audible or visual signal to alert the person replacing the implement that he or she is returning the implement to an improper location.

In one illustrative embodiment, the invention described in U.S. Pat. No. 6,014,078 comprises plural transmitters, each transmitter adapted to be connected to a respective weightlifting implement and operative to transmit a unique identification signal to identify the corresponding implement. Each weightlifting implement of the embodiment houses a power supply unit therein in the form of one or more batteries to supply electrical power to the corresponding transmitter. The power in the batteries may be conserved by a motion sensor and switch, which efficiently save power by shutting off the transmitter during inactive periods, such as when the weightlifting implement is racked for an extended period of time.

However, when the batteries housed within the aforementioned weightlifting implements run out of energy, they ultimately need to be replaced. There is thus a need in the art for a system comprising a power supply unit for a weightlifting implement that avoids this problem.

### SUMMARY

According to various embodiments of the disclosed technology, the present invention relates to a rack for weightlifting implements that has a wireless charging system for the implements. In one embodiment, the wireless charging system allows sensors, accelerometers, transmitters, and other electronic components on the weightlifting implements that previously needed easily replaceable batteries to be charged inductively.

The present disclosure, in one embodiment, provides a system comprising at least one weight lifting implement that includes: a battery; at least one receiver induction coil configured to receive energy via inductive coupling; and a circuit operatively coupled to the battery and the at least one receiver induction coil, where the circuit is configured to charge the battery with energy received at the at least one receiver induction coil via inductive coupling. The system additionally comprises at least one charging station comprising a transmitter induction coil configured to transfer energy to the at least one receiver induction coil via inductive coupling.

The present disclosure, in one embodiment, provides a weight lifting implement comprising: at least one electronic component; at least one receiver induction coil configured to receive energy via inductive coupling; and a battery operatively coupled to the at least one receiver induction coil and configured to store the energy for powering the at least one electronic component.

The present disclosure, in one embodiment, provides a storage device configured to receive one or more weight lifting implements, where the storage device comprises: at least one transmitter induction coil configured to transfer energy to at least one receiver induction coil of at least one weight lifting implement via inductive coupling; and a power supply operatively coupled to the at least one transmitter induction coil.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that, for clarity and ease of illustration, these drawings are not necessarily made to scale.

FIG. 1 is a perspective view of a dumbbell rack that has an inductive charging system for the dumbbells and having dumbbells placed on the rack, in accordance with one embodiment of the technology described herein.

FIG. 2 is a perspective, partial view of a dumbbell rack and dumbbells similar to the dumbbell rack and dumbbells shown in FIG. 1, in accordance with one embodiment of the technology described herein.

FIGS. 3A-3C are perspective views of a dumbbell having at least one charging unit (3A), at least two charging units (3B), and at least four charging units (3C) for charging an electronic component contained within the dumbbell, in accordance with one embodiment of the technology described herein.

FIG. 4 is a diagram of an induction coil for use in the dumbbell racks and dumbbells of FIGS. 1, 2 and 3A-3C, in accordance with one embodiment of the technology described herein.

FIG. 5 is a perspective view of a barbell rack that has an inductive charging system for a barbell and having a barbell placed on the rack, in accordance with one embodiment of the technology described herein.

FIG. 6 is a perspective view of a plate tree that has an inductive charging system for weight plates and having a weight plates placed on the tree, in accordance with one embodiment of the technology described herein.

FIG. 7 is a simplified schematic of a wireless inductive charging system for a weight lifting implement, in accordance with one embodiment of the technology described herein.

The figures are not intended to be exhaustive or to limit the invention to the precise form disclosed. It should be understood that the invention can be practiced with modification and alteration.

### DETAILED DESCRIPTION

Embodiments of the technology disclosed herein are directed toward devices and methods for providing electric charging of monitoring and transmitting systems in weightlifting implements. More particularly, various embodiments of the technology disclosed herein relate to inductive charging of monitoring and transmitting systems in weightlifting implements.

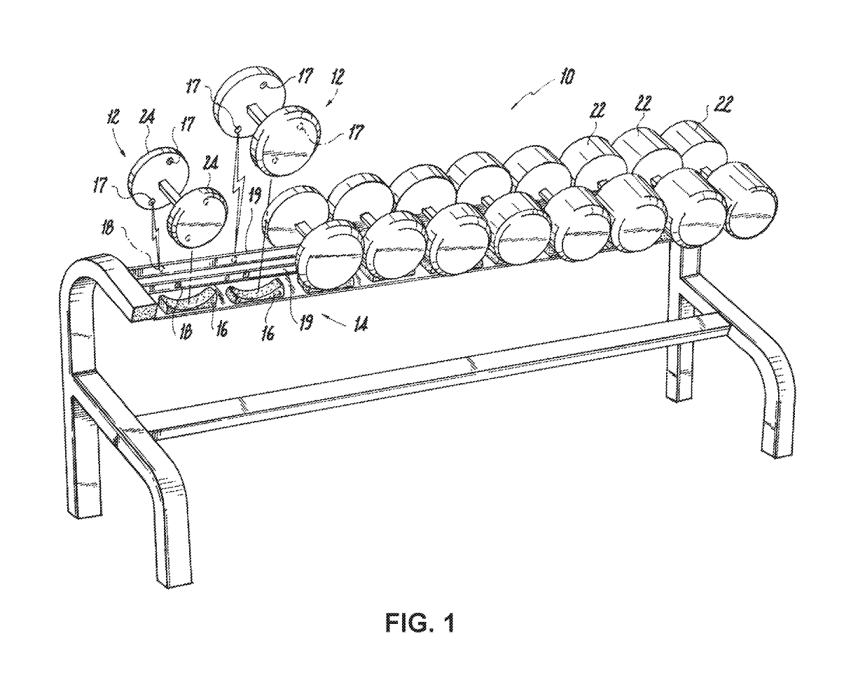

With reference to the figures, FIG. 1 is a perspective view of a dumbbell rack 10 that has an inductive charging system for the dumbbells 12, 22 and having the dumbbells placed on the rack, in accordance with one embodiment of the technology described herein. The dumbbell rack 10 comprises a weightlifting implement storage device 14 having a plurality of cradles 16.

In the illustrative embodiment shown in FIG. 1, each dumbbell 12, 22 includes one or more charging units 17 that are operative to charge one or more batteries or power supply units contained within the dumbbell. The dumbbell rack 10, in turn, includes one or more charging stations 18 that are operative to transfer energy to the charging units 17.

In the illustrative embodiment shown in FIG. 1, the charging stations 18 are mounted to rails 19 adjacent to the cradles 16 of the storage device 14. The charging stations 18 are recessed a selected distance from the surface of the rails 19 to prevent the dumbbells 12, 22 from damaging the charging stations as the dumbbells are replaced in the cradles 16. It will be understood by those of ordinary skill in the art that the charging stations 18 may alternately be placed in different locations on or near the cradles. For example, the charging stations 18 may be embedded in the cradles 16 or in a platform or panel running between the front and rear portions of the cradles 16. Thus, the placement shown in FIG. 1 is intended to be exemplary only.

The charging units 17 in one embodiment are disposed on the inwardly facing surface of one of the plates 24 of the dumbbells 12, 22. In one illustrative embodiment, each dumbbell 12, 22 includes more than one charging unit 17, with the charging units being located at preselected spaced-apart locations on the inwardly facing surface of one of the dumbbell plates 24. In another embodiment, the charging units 17 can be mounted on the inwardly facing surfaces of both plates 24 of each dumbbell 12, 22. It will be understood that each dumbbell 12, 22 may alternatively include only one charging unit 17. The charging units 17 are designed to create an electromagnetic field to transfer energy to the charging units 18 in the dumbbells 12, 22.

Rather than being located on the inwardly facing surfaces of the dumbbell plates 24, the charging units 17 could alternatively be placed on the outer facing surfaces of the plates, on the edges of the plates, on the handles of each dumbbell 12, 22, or in another suitable location. In the case where there are two charging units 17 per dumbbell 12, 22, the charging units are preferably disposed on diametrically opposed sides of the same dumbbell plate 24 to ensure energy transfer from the charging stations 18 on the rails 19.

In one embodiment, there is a direct line of sight between a charging unit 17 and a charging station 18 when a dumbbell 12, 22 is placed on a cradle 16. In a particular embodiment, the distance from a charging unit 17 to a charging station 18 when a dumbbell 12, 22 is placed on a cradle 16 is approximately six inches or less.

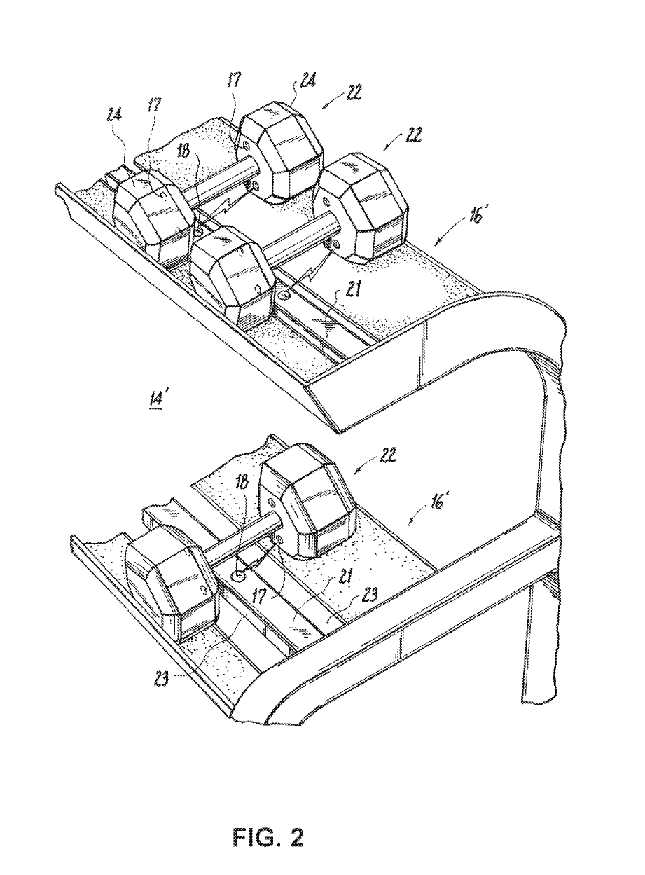

FIG. 2 is a perspective, partial view of a weightlifting implement storage device 14′ and dumbbells 22 similar to the storage device and dumbbells shown in FIG. 1, in accordance with one embodiment of the technology described herein. The storage device 14′ of FIG. 2 is a two-level storage device that has preselected locations 16′ for each of the dumbbells 22, similar to the cradles 16 in FIG. 1. In this embodiment, the charging stations 18 are mounted in a track 21 that is interposed between the plates 24 of the dumbbells 22. The charging stations 18 could alternatively be mounted on the upstanding side walls 23 of the track 21 or in another suitable location, so long as the charging stations can transfer energy to the charging units 17.

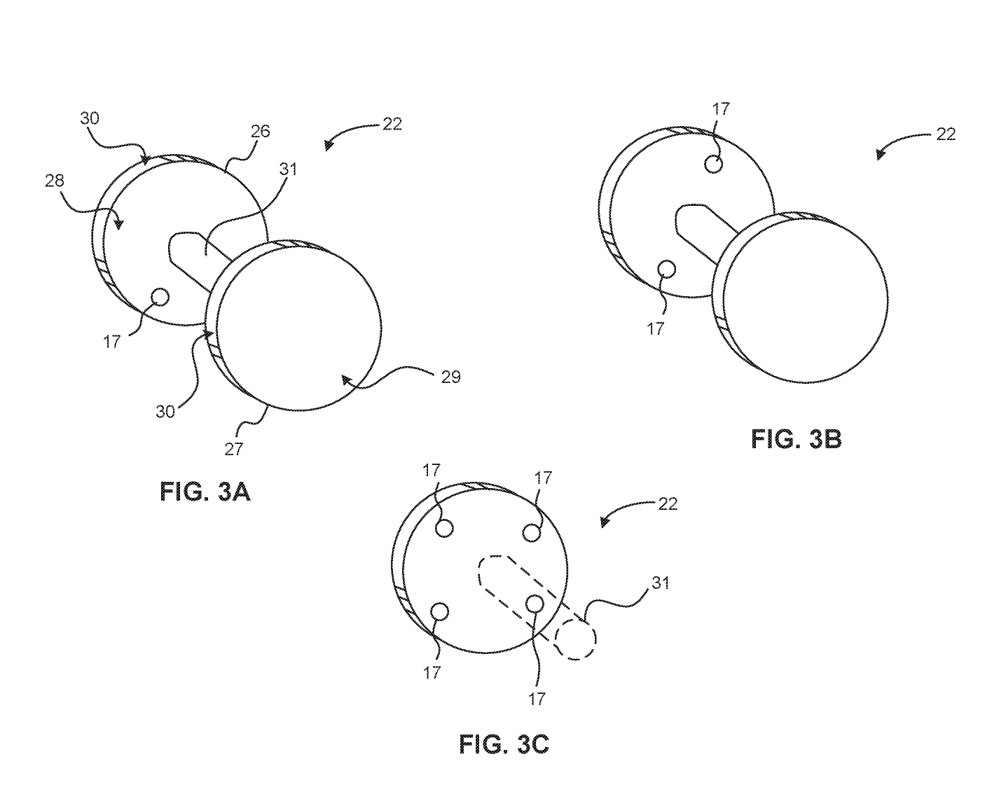

FIGS. 3A-3C are perspective views of a dumbbell 22 having one or more charging units 17 for charging an electronic component contained within the dumbbell 22, in accordance with one embodiment of the technology described herein. As shown in FIGS. 3A-3C, the dumbbell 22 comprises a first end portion 26 and a second end portion 27 in spaced relation with one another. The first and second end portions 26, 27 may also be referred to as “plates.” The first and second end portions 26, 27 each comprise an interior surface 28, an exterior surface 29, and a circumferential periphery 30. In some embodiments, the first end portion 26 has a same circumference as the second end portion 27. However, in some embodiment, the first end portion 26 has a difference circumference as the second end portion 27. As also shown in FIGS. 3A-3C, the dumbbell 22 additionally comprises a handle portion 31 disposed between the first and second end portions 26, 27 and physically coupled to the interior surfaces 28 thereof.

In some embodiments, the dumbbell 22 comprises one charging unit 17, as shown in the embodiment of FIG. 3A. This charging unit 17 may be physically coupled to a portion of the interior surface 28 of either the first or second end portions 26, 27. For instance, in one such embodiment, the charging unit 17 is physically coupled to the interior surface of the first end portion 26, and particularly located in a region between the handle portion 31 and the circumferential periphery 30 thereof. In one embodiment, the charging unit 17 is mounted within a recess formed in the inwardly facing surface (i.e., the interior surface 28) of one of the plates (end portions 26, 27) of the dumbbell 22.

In one embodiment, a charging unit 17 is physically coupled to the interior surface 28 of the first end portion 26 of the dumbbell 22, and a second charging unit 17 is physically coupled to the interior surface 28 of the second end portion 27 of the dumbbell 22. In one such embodiment, the second charging unit 17 may be mounted within a recess formed in the inwardly facing surface (i.e., the interior surface 28) of the other plate (the second end portion 27) of the dumbbell 22.

In some embodiments, the dumbbell 22 comprises two charging units 17 physically coupled to an interior surface 28 of at least one of the end portions 26, 27, as shown in the embodiment of FIG. 3B. The two charging units 17 may be separated from one another by a predetermined distance.

In one embodiment, two charging units 17 are physically coupled to the interior surface 28 of the first end portion 26 of the dumbbell 22, and two charging units 17 are physically coupled to the interior surface 28 of the second end portion 27 of the dumbbell 22. In one such embodiment, the positions of the two charging units 17 on the interior surface 28 of the first end portion 26 are different/staggered relative to the positions of the two charging units 17 on the interior surface 28 of the second end portion 27.

In some embodiments, the dumbbell 22 comprises four charging units 17 physically coupled to an interior surface 28 of at least one of the end portions 26, 27, as shown in the embodiment of FIG. 3C. For clarity, the second end portion 27 has been removed from the view provided in FIG. 3C. Each charging unit 17 may be separated from an adjacent charging unit 17 by a predetermined distance. In one embodiment, the relative spacing between each of the four charging units 17 may be uniform.

In one embodiment, four charging units 17 are physically coupled to the interior surface 28 of the first end portion 26 of the dumbbell 22, and four charging units 17 are physically coupled to the interior surface 28 of the second end portion 27 of the dumbbell 22. In one such embodiment, the positions of at least one of the charging units 17 on the interior surface 28 of the first end portion 26 is different/staggered relative to the position of a charging unit 17 on the interior surface 28 of the second end portion 27. In another such embodiment, the positions of all four charging units 17 on the interior surface 28 of the first end portion 26 are different/staggered relative to the positions of the four charging units 17 on the interior surface 28 of the second end portion 27.

It is important to note that the embodiments illustrated in FIGS. 3A-3C are not limiting in any way. For instance, as discussed herein, the interior surface 28 of at least one of the end portions 26, 27 of the dumbbell may have any number of charging units 17 physically coupled thereto, such as one charging unit, two charging units, three charging units, four charging units, five charging units, six charging units, seven charging units, eight charging units, etc. Further, in some embodiments, the interior surface 28 of both the first end portion 26 and the second end portion 17 may each have any number of charging units 17. In such embodiments, the interior surface 28 of the first end portion 26 may have the same or a different number of charging units 17 as the interior surface 28 of the second end portion 27. In yet more embodiments, the dumbbell 22 may comprise one or more charging units coupled along the circumferential periphery 30 of at least one of the end portions 26, 27; coupled to the exterior surface 29 of at least one of the end portions 26, 27; and/or coupled to the handle portion 31. In still more embodiments, at least one of the end portions 26, 27 may comprise one or more charging units 17 physically coupled to the interior surface 28 thereof, as well as one or more charging units physically coupled to at least one of: the circumferential periphery 30 thereof; the exterior surface 29 thereof; and the handle portion 31.

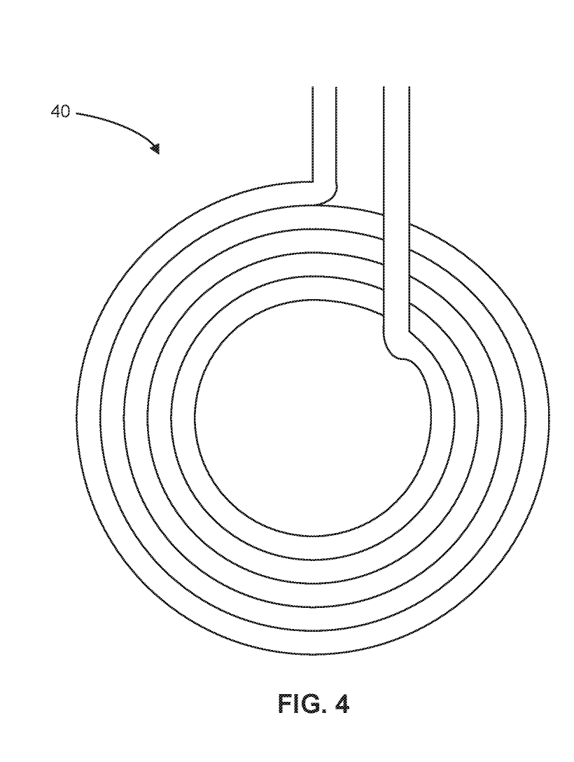

FIG. 4 is a diagram of an induction coil 40 for use in the dumbbell racks and dumbbells of FIGS. 1, 2 and 3, in accordance with one embodiment of the technology described herein. The induction coil 40 of the charging station 18 uses an electromagnetic field to transfer energy to the charging unit 17 of a dumbbell 12, 22. The energy is sent through inductive coupling by the charging station 18 to the charging unit 17, which is configured to use that energy to charge one or more batteries or power supply units contained within the dumbbell 12, 22.

In one embodiment, the induction coil 40 of the charging station 18 creates an alternating electromagnetic field. The induction coil 40 of the charging unit 17 takes energy from the electromagnetic field and converts it into electric current to charge the one or more batteries or power supply units contained within the dumbbell 12, 22. In this embodiment, the two induction coils 40 combine to form a type of electrical transformer, transferring electrical energy from the induction coil 40 of the charging station 18 to the charging unit 17 of the dumbbell 12, 22 through electromagnetic induction.

In one embodiment, the induction coil 40 of the charging station 18 is connected to electrical wires and components contained within the dumbbell rack that receive electrical current from a wall outlet. The varying electrical current in the winding of the charging-station induction coil 40 creates a varying magnetic field in the core of the charging-unit induction coil 40. This varying magnetic field induces a varying electromotive force or voltage in the winding of the charging-unit induction coil 40 due to electromagnetic induction. In a particular embodiment, the induction coil is encased in a disc-shaped plastic covering having openings for the electrical wires.

In some embodiments, an induction coil 40 associated with a weight lifting implement, such as the aforementioned dumbbell, may be referred to as a “charging-unit induction coil” or a “receiver induction coil.” Similarly, an induction coil 40 associated with a storage device configured to receive a weight lifting implement, such as the aforementioned dumbbell rack, may be referred to as a “charging-station induction coil” or a “transmitter induction coil.”

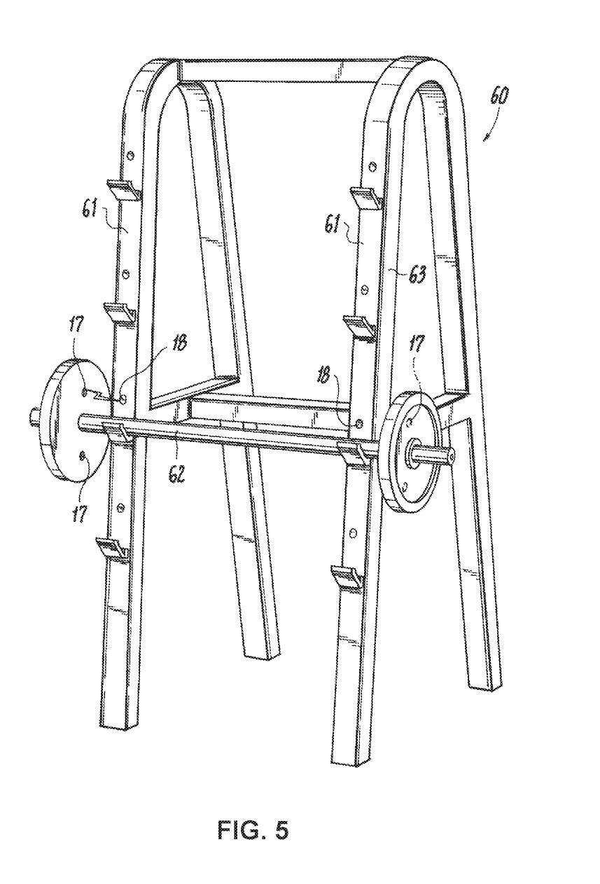

FIG. 5 is a perspective view of a barbell rack 60 that has an inductive charging system for a barbell 62 and having a barbell placed on the rack, in accordance with one embodiment of the technology described herein. Mounted into one or more plates of the barbell 62 are one or more charging units 17, as described above in connection with the dumbbells 12, 22. Charging stations 18 are disposed on the barbell rack 60 at selected locations to transfer energy to the charging units 17. The barbell rack 60 and barbell 62 then operate in a similar manner as described above respecting the dumbbell rack 10 and dumbbells 12, 22. While the charging stations 18 are shown mounted on the forward facing surfaces 61 of the barbell rack 60, they may alternatively be placed on the side surfaces 63 of the rack or at another suitable location so that there is a direct line of sight between a charging unit 17 and a charging station 18 when a barbell 62 is placed on the rack.

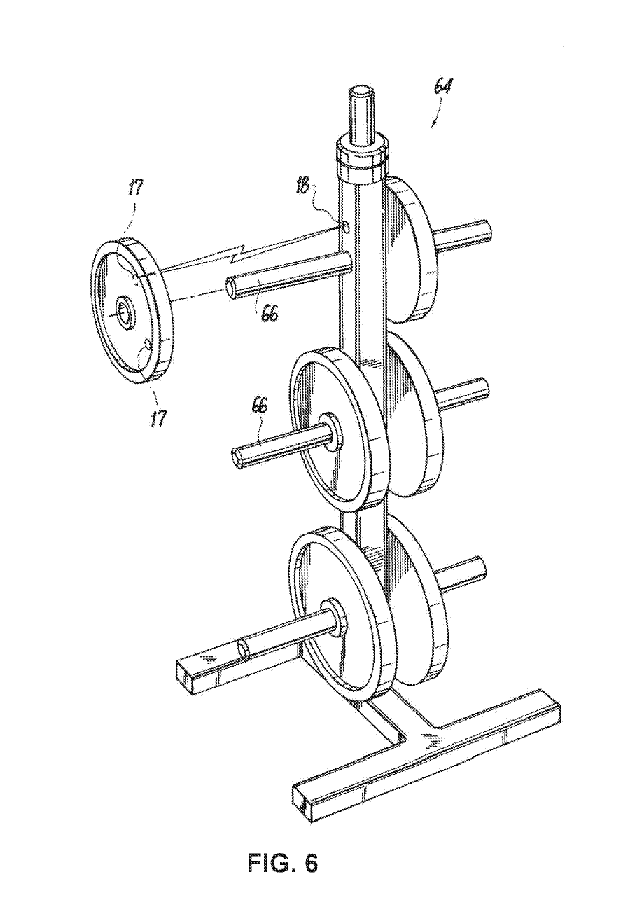

FIG. 6 is a perspective view of a plate tree 64 that has an inductive charging system for weight plates and having weight plates placed on the tree, in accordance with one embodiment of the technology described herein. The plate tree 64 includes outwardly projecting cylindrical posts 66 to receive the weight plates. A plurality of charging stations 18 are disposed at selected locations on the plate tree 64 to transfer energy to charging units 17 mounted on the weight plates. The plate tree 64 and weight plates then operate in a similar manner as described above respecting the dumbbell rack 10 and dumbbells 12, 22.

In one embodiment, the charging stations 18 are disposed on an upright portion of the plate tree 64 so that there is a direct line of sight between a charging unit 17 and a charging station 18 when a weight plate is placed on a cylindrical post 66. In another embodiment, the charging stations are embedded in the cylindrical posts 66 so that weight plates placed farther away from the upright portion of the plate tree 64 can be more efficiently charged.

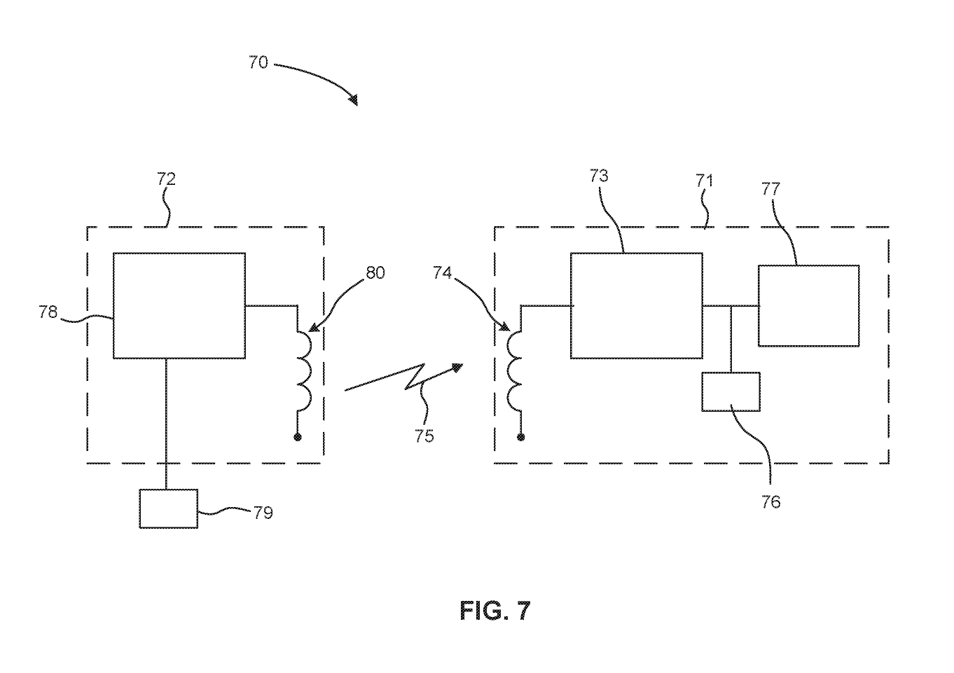

FIG. 7 is a simplified schematic of a wireless inductive charging system 70 for a weight lifting implement, in accordance with one embodiment of the technology described herein. The wireless inductive charging system 70 comprises a weight lifting implement 71, and a storage device 72 configured to receive the weight lifting implement 71. The weight lifting implement comprises a first circuit 73 operatively coupled to: at least one receiver induction coil 74 configured to receive energy via inductive coupling 75; at least one battery 76 configured to store the energy received at the receiver induction coil 74; and at least one electronic component 77 powered by the at least one battery 76. The energy received at the at least one receiver induction coil 74 is provided to the battery 76 via the first circuit 73.

As also shown in FIG. 7, the storage device 72 comprises a second circuit 78 operatively coupled to a power supply 79, and at least one transmitter induction coil 80 configured to transfer energy to the at least one receiver induction coil 74 of the weight lifting implement 71. In one embodiment, the power supply 79 provides current to the transmitter induction coil 80 via the second circuit 78. In some embodiments, the power provided by the power supply 79 is first converted into alternating current prior to arriving at the at least one transmitter induction coil 80.

In some embodiments, the current flowing throw the transmitter induction coil 80 creates a magnetic field, which extends to the at least one receiver induction coil 74 when the receiver and transmitter induction coils 74, 80 are within a predetermined distance of each other. This magnetic field generates a current within the receiver induction coil 74, which is then provided to the at least one battery 76 for charging thereof. In some embodiments, the current generated in the at least one receiver coil 74 is converted into direct current prior to arriving at the at least one battery 76. The energy provided to the at least one battery 76 may then be utilized for powering the one or more electronic components 77 of the weight lifting implement 71.

In some embodiments, the at least one receiver induction coil 74 and the at least one transmitter induction coil 80 may have a form as shown in FIG. 3. In such embodiments, the receiver and transmitter induction coils 74, 80 may be oriented parallel to one another, such that the substantially flat surfaces thereof face each other, to allow efficient transfer of energy via inductive coupling.

While not shown in FIG. 7, the first circuit 73 of the weight lifting implement 71, in some embodiments, may comprise a first switch configured to selectively: isolate the at least one receiver induction coil 74 from the at least one battery 76, or connect the at least one receiver induction coil 74 to the at least one battery 76. In one such embodiment, a controller operatively coupled to the first circuit 73 may issue a switch control signal to operate the first switch. In another such embodiment, a controller operatively coupled to the second circuit 78 may send, e.g., via a wireless network, a switch control signal to the first circuit 72 for operation of the first switch.

In some embodiments, the second circuit 78 of the storage device 72 may comprise a second switch configured to selectively: isolate the power supply 79 from the at least one transmitter induction coil 80, or connect the power supply 79 to the at least one transmitter induction coil 80. In one such embodiment, a controller operatively coupled to the second circuit 78 may send a switch control signal to operate the second switch. In another such embodiment, a controller operatively coupled to the first circuit 73 may send, e.g., via a wireless network, a switch control signal to the second circuit 78 for operation of the second switch.

In some embodiments, energy may be transferred from the at least one transmitter induction coil 80 to the at least one receiver induction coil 74 via resonant inductive coupling. In such embodiments, the at least one transmitter induction coil 80 and the at least one receiver induction coil 74 may be selectively tuned to resonate at the same frequency. Resonant inductive coupling may allow for the transfer of energy between the at least one transmitter induction coil 80 and the at least one receiver induction coil 74 in instances where there is a greater degree of misalignment between x, y and/or z axes of the receiver and transmitter induction coils 74, 80 as compared to inductive coupling. Further, resonant inductive coupling may allow one transmitter induction coil 80 to transfer energy to more two or more receiver induction coils 74 simultaneously.

In some embodiments, the at least one receiver coil 74 and the at least one transmitter coil 80 may include any known configuration, material(s), etc. for the transfer of energy via inductive or resonant inductive coupling. Similarly, the first and second circuits 73, 78 of the at least one weight lifting implement 71 and the storage device 72, respectively, may include any configuration or circuitry as would be appreciated by skilled artisans upon reading the present disclosure.

While various embodiments of the disclosed technology have been described above, it should be understood that they have been presented by way of example only, and not of limitation. Likewise, the various figures may depict an example configuration for the disclosed technology, which is done to aid in understanding the features and functionality that can be included in the disclosed technology. The disclosed technology is not restricted to the illustrated example configurations, but the desired features can be implemented using a variety of alternative configurations.

What is claimed is:

1. A system for wirelessly charging a weight lifting implement, the system comprising:
at least one weight lifting implement comprising:
a battery;
at least one receiver induction coil configured to receive energy via inductive coupling; and
a circuit operatively coupled to the battery and the at least one receiver induction coil, wherein the circuit is configured to charge the battery with energy received at the at least one receiver induction coil via inductive coupling; and
at least one charging station comprising a transmitter induction coil configured to transfer energy to the at least one receiver induction coil via inductive coupling.

2. The system of claim 1, wherein the at least one weight lifting implement comprises at least two receiver induction coils.

3. The system of claim 1, wherein the at least one charging station is physically coupled to a portion of a storage device, wherein the storage device is configured to receive the at least one weight lifting implement.

4. The system of claim 3, wherein the storage device further comprises a second circuit operatively coupled to the transmitter induction coil and a power source.

5. The system of claim 4, wherein the storage device further comprises at least two charging stations physically coupled thereto.

6. The system of claim 1, further comprising a plurality of weight lifting implements, each weight lifting implement comprising:
a battery; and
a receiver induction coil configured to receive energy transferred thereto via inductive coupling.

7. The system of claim 1, wherein the at least one weight lifting implement comprises at least one electronic component powered by the battery.

8. The system of claim 7, wherein the at least one electronic component is selected from the group consisting of: a sensor, an accelerometer, and a transmitter.

9. A weight lifting implement, comprising:
at least one electronic component;
at least one receiver induction coil configured to receive energy via inductive coupling; and
a battery operatively coupled to the at least one receiver induction coil and configured to store the energy for powering the at least one electronic component.

10. The weight lifting implement of claim 9, wherein the battery is operatively coupled to the at least one receiver induction coil via a circuit configured to facilitate transfer of the energy from the least one receiver induction coil to the battery.

11. The weight lifting implement of claim 9, wherein the at least one receiver induction coil is configured to receive the energy when the at least one receiver induction coil is within a predetermined distance from at least one transmitter induction coil.

12. The weight lifting implement of claim 11, wherein the at least one transmitter induction coil is physically coupled to a storage device configured to receive the weight lifting implement.

13. The weight lifting implement of claim 9, further comprising:
a first end portion and a second end portion in spaced relation with one another, wherein an interior surface of the first end portion faces an interior surface of the second end portion; and
a handle portion disposed between the first and second end portions and physically coupled to the interior surfaces thereof,
wherein the at least one receiver induction coil is physically coupled to the interior surface of the first end portion or the interior surface of the second end portion.

14. The weight lifting implement of claim 13, wherein at least a second receiver induction coil is physically coupled to the interior surface of the first end portion or the interior surface of the second end portion.

15. The weight lifting implement of claim 9, further comprising:
a first portion parallel to a second portion, wherein the first and second portions have a same circumferential periphery, wherein an exterior surface of the first portion faces away from an exterior surface of the second end portion; and
a third portion connecting the first portion to the second portion and disposed along the circumferential periphery,
wherein the at least one receiver induction coil is physically coupled to the exterior surface of the first portion or the exterior surface of the second portion.

16. The weight lifting implement of claim 15, wherein at least a second receiver induction coil is physically coupled to the exterior surface of the first portion or the exterior surface of the second portion.

17. A storage device configured to receive one or more weight lifting implements, the storage device comprising:
at least one transmitter induction coil configured to transfer energy to at least one receiver induction coil of at least one weight lifting implement via inductive coupling; and
a power supply operatively coupled to the at least one transmitter induction coil.

18. The storage device of claim 17, further comprising a circuit configured to transfer current from the power supply to the at least one transmitter induction coil.

19. The storage device of claim 17, further comprising a plurality of transmitter induction coils, each transmitter induction coil operatively coupled to the power supply and configured to transmit energy to at least one receiver induction coil of at least one weight lifting implement via inductive coupling.
